(19) United States
(12) Patent Application Publication
(10) Pub. No.: US 2026/0095079 A1
(43) Pub. Date: Apr. 2, 2026

(54) GROUNDING BRUSH, A GROUNDING BRUSH UNIT AND A DEVICE

(71) Applicants: AKTIEBOLAGET SKF, GOTEBORG (SE); SKF Aerospace France S.A.S, Perrigny (FR)

(72) Inventors: Benoît HAUVESPRE, Saint Etienne de Chigny (FR); Franck GERVAIS, Bourg de Péage (FR); Thomas PERROTIN, Saint Roch (FR); Emmanuel BENEVISE, Monts (FR)

(21) Appl. No.: 19/331,066

(22) Filed: Sep. 17, 2025

(30) Foreign Application Priority Data
Sep. 27, 2024 (DE) 102024209449.8

(51) Int. Cl. H02K 13/10; H01R 39/24

(52) U.S. Cl. CPC H02K 13/10; H01R 39/24

(57) ABSTRACT

A grounding brush has a first set of filaments, which belong to a first type, and at least a second set of filaments. The filaments of the second set of filaments belong to a second type, which differs from the first type.

### CROSS-REFERENCE

This application claims priority to German patent application no. 102024209449.8 filed on Sep. 27, 2024, the contents of which are fully incorporated herein by reference.

### BACKGROUND OF THE INVENTION

The present invention relates to electrically conductive devices, and more particularly to grounding brush, a grounding brush unit and a device with a grounding brush unit.

A grounding brush with graphite filaments is known. Moreover, it is known to use grounding brushes on coated areas of shafts and on coated bushes, which are located on a shaft.

### SUMMARY OF THE INVENTION

The problem of the invention is in particular to reach a high efficiency. The problem is solved according to the present invention, which is directed to a grounding brush comprising a first set of filaments of a first type and a second set of filaments of a second type, the second type differing from the first type. Advantageous embodiments of the invention are disclosed in the dependent claims.

The invention proceeds from a grounding brush with a first set of filaments, which belong to a first type, and at least a second set of filaments.

It is proposed that the filaments of the second set belong to a second type, which differs from the first type. Under the phrase that a filament “belongs to a type” it is in particular supposed to be understood that the filament consists of a material, which is for the type specific, and/or has a mass, which deviates by less than 20 percent by weight from a mass, which is specific for the type, and/or has an electrical conductivity, which deviates by less than 20% from an electrical conductivity, which is specific for the type. Under the phrase that the second type “differs” from the first type it is in particular supposed to be understood that a material, which is specific for the first type, differs from a material, which is specific for the second type, and/or that a mass, which is specific for the first type, deviates by more than 5% from a mass, which is specific for the second type, and/or that an electrical conductivity, which is specific for the first type, deviates by more than 5% from an electrical conductivity, which is specific for the second type. Under a “set” in particular a set in the mathematical sense is supposed to be understood. Through this a high efficiency can be achieved. In particular, a good formation of a property of the grounding brush, which differs from electrical conductivity, can be reached.

In particular, a filament can be a fiber and/or a bristle and/or a piece of wire. In particular, the filaments of the first set can be electrically conductive. For example, the filaments of the first set can be carbon fibers.

With advantage the filaments of the second set consist at least for the most part of one solid lubricant or more than one solid lubricants. Under the phrase that a filament consists “for the most part” of a certain material, it is in particular supposed to be understood that a part of the filament, which comprises more than fifty percent by weight of the filament, consists of this material. Thereby a good lubrication of a relative movement between the filaments of the first set and a shaft during an operation procedure can be achieved, in particular in a case in which a surrounding of the filaments of the first set is dry and therefore without a liquid lubricant. In particular, friction between the filaments of the first set and the shaft can be low and abrasive wear and oxidation of the shaft and a decrease of an electrical conductivity between the filaments of the first set and the shaft can be avoided to a good extent.

Moreover, it is suggested that the filaments of the second set consist at least partially of polytetrafluoroethylene and/or of graphene. Through this low noise during operation, low wear of a shaft, which is in contact with the filaments of the second set during operation, and a good ability to keep contact to the shaft during operation can be achieved.

With advantage the grounding brush comprises a third set of filaments, which belong to a third type, and the third type differs from the first type and from the second type. Through this a high efficiency can be reached. In particular, a good formation of a few properties of the grounding brush, which differ from electrical conductivity, can be achieved. In particular, the filaments of the third set can have a better thermal conductivity than the filaments of the first set and the second set.

Furthermore, it is proposed that the filaments of the second set have a higher thermal conductivity than the filaments of the first set. Through this a good cooling and a low wear of material, which is during operation in contact with the grounding brush, can be achieved.

In particular, a thermal conductivity, which is specific for the filaments of the second type, can be at least 15% higher than a thermal conductivity, which is specific for the filaments of the first type.

With advantage the filaments of the second set are Pitch-based carbon fibers. Thereby an especially high thermal conductivity of the filaments of the second set can be reached.

Advantageously a total number of the filaments of the first set is between 40% and 75% of a total number of filaments of the grounding brush and/or a total number of the filaments of the second set is between 25% and 60% of the total number of the filaments of the grounding brush. Through this an effectiveness of the filaments of the first set and an effectiveness of the filaments of the second set are well balanced.

Moreover, a grounding brush unit with a grounding brush as described above is suggested, wherein a carrier unit is fixed to the grounding brush. Thereby an efficient mounting possibility of the grounding brush to a housing can be reached.

Furthermore, a device with the grounding brush unit is proposed.

Advantageously the device comprises a shaft with a surface area, which contacts the grounding brush and which is free from coatings. Through this a cost-efficient construction can be achieved.

### BRIEF DESCRIPTION OF THE SEVERAL VIEWS OF THE DRAWINGS

Further advantages can be seen in the following description of the drawings. An example of an embodiment of the invention is shown in the drawings. The drawings, the description and the claims contain numerous features in combination. The skilled person will expediently also consider the features individually and combine them to form useful further combinations.

FIG. 1 shows a view on a face side of a grounding brush unit with a grounding brush according to the invention;

FIG. 2 shows a II-II section through the grounding brush unit according to FIG. 1;

FIG. 3 shows a III-III section through a device with the grounding brush unit according to FIG. 1; and

FIG. 4 shows a perspective view of the grounding brush unit.

### DETAILED DESCRIPTION OF THE INVENTION

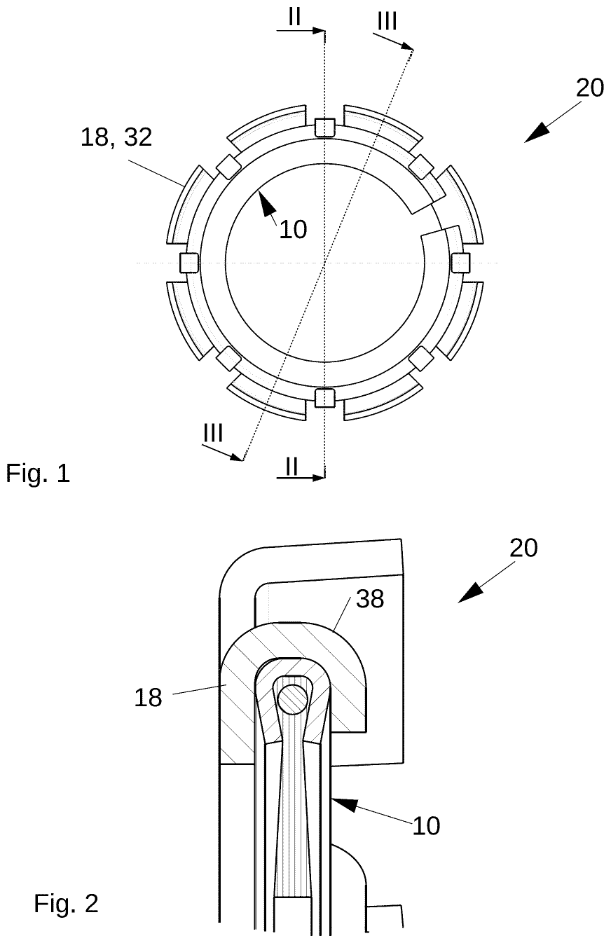

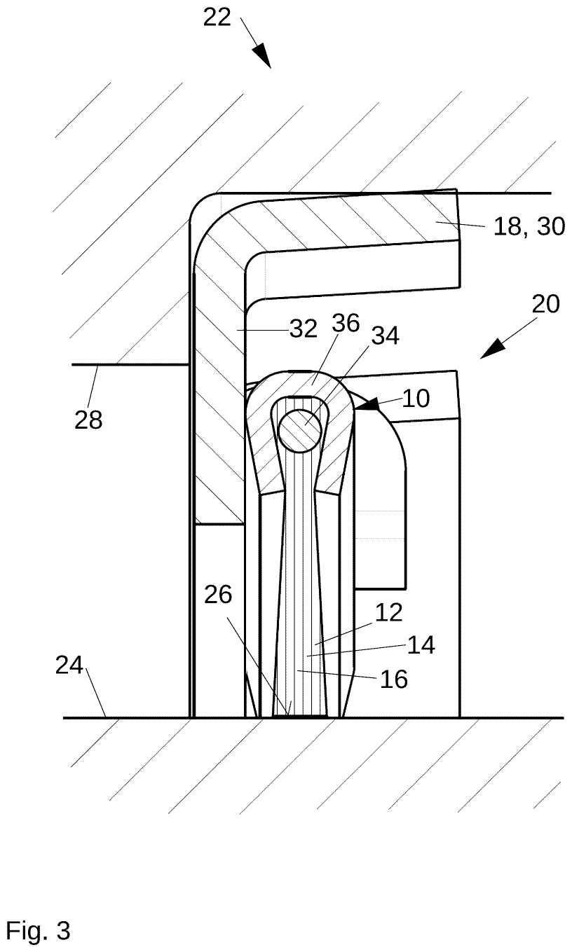

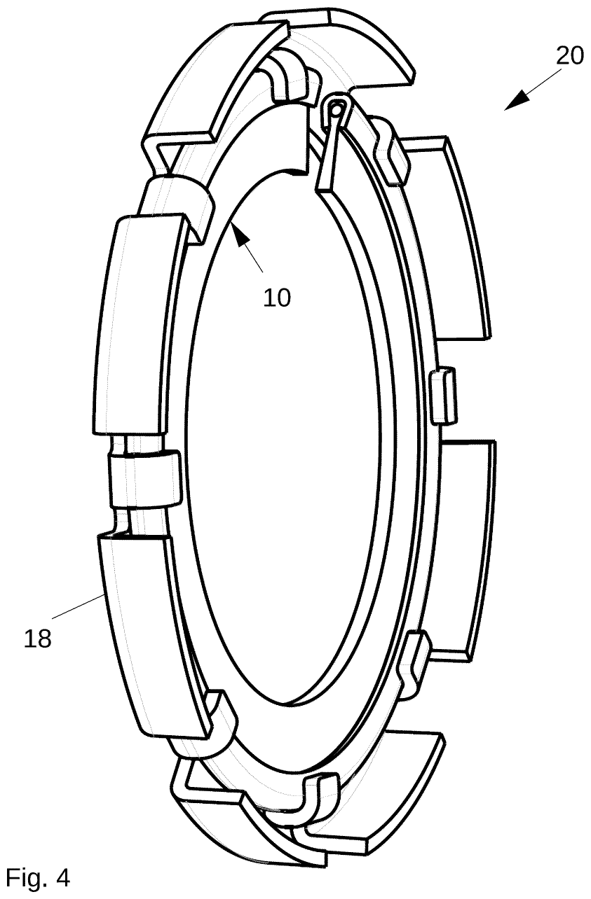

FIG. 1 shows a view on a face side of a grounding brush unit 20 with a grounding brush 10 according to the invention. The grounding brush unit 20 comprises a one-piece metal carrier unit 18, which is fixed to the grounding brush 10 in a form-fit way (FIGS. 1-4). The grounding brush comprises a first set of filaments 12 (FIG. 3), which belong to a first type. Moreover, the grounding brush comprises a second set of filaments 14, which belong to a second type. The first type and the second type differ from each other. The filaments 12 of the first set are carbon fibers, which are electrically conductive. Preferably, the filaments 14 of the second set consist completely of graphene. Alternatively, the filaments 14 of the second set consist partially or completely of Polytetrafluoroethylene. As a further alternative, it is also possible that the second set of filaments includes a group of filaments which consist completely or partially of Polytetrafluoroethylene and remaining filaments which consist of graphene. Therefore, the filaments 14 of the second set consist at least partially of a solid lubricant. The filaments 14 of the second set also provide a cleaning effect during operation.

Furthermore, the grounding brush 10 may comprise a third set of filaments 16, which belong to a third type. Preferably, the filaments 16 of the third type are Pitch-based carbon fibers. The filaments 16 of the third set have a higher thermal conductivity than the filaments of the first set. Therefore, the filaments 16 contribute to cooling of a shaft 24 in a fully assembled state. In the fully assembled state, the grounding brush unit 20 is part of a device 22 (FIG. 3). In this state, the carrier unit 18 is fixed in a press fit way to a housing 28 of the device 22 through parts 30 of ring segment shaped pieces 32 of the carrier unit 18, which extend in an axial direction of the grounding brush 10.

The grounding brush 10 preferably has the shape of a ring segment. This ring segment is almost a ring, but with two open ends. All the filaments of the grounding brush 10 are fixed with the help of a wire 34 to a carrier element 36 of the grounding brush 10. The carrier element 36 has also the shape of a ring segment. Moreover, the last-mentioned ring segment of the carrier element 36 is also almost a ring. In an axial section (FIGS. 2 and 3) the carrier element 36 is U-shaped, wherein ends of the carrier element 36 are bent towards each other such that they press the filaments of the grounding brush 10 together, which results in a fixation of the filaments to the carrier element 36. Lugs 38 of the carrier unit 18 are bent around the carrier element 36 such that the carrier element 36 is fixed to the carrier unit 18 (FIG. 2). In total the filaments of the grounding brush 10 are connected by the carrier element 36 and the carrier unit 18 to the housing 28 in an electrically conductive way. The housing 28 is also electrically conductive.

The device 22 comprises the shaft 24, which rotates relative to the housing 28 and relative to the grounding brush unit 20 during operation. The shaft 24 comprises a surface area 26, which contacts the grounding brush 10 and which is free from coatings.

The shaft 24 is rotatably supported relative to the housing 28 by a bearing (not shown). In particular during an operating procedure an electrical current can flow from the shaft 24 through in particular the first set of filaments 12 and through the carrier element 36 and the carrier unit 18 to the housing 28. This prevents electric current from flowing through a proximal bearing (not depicted) to the housing 28, which protects the bearing from damage.

The device 22 can be free from a liquid lubricant in a region containing the grounding brush 10.

The device 22 can for example be a part of an electrical motor, which supplies drive or motive power to a vehicle or which is a part of an industrial application.

All the filaments of the grounding brush 10 can be fibers.

FIG. 4 shows a perspective view of the grounding brush unit 20.

Compared to a grounding brush with graphite fibers the grounding brush of the invention has in particular the following advantages: lower noise, lower wear (which increases the lifetime of the components, in particular the shaft) and a better ability to keep contact to the shaft due to the flexibility of the filaments.

Alternatively, the grounding brush 10 may be free from the filaments 16 of the third set. In this case, a total number of the filaments 12 of the first set is between 40% and 75%, in particular between 50% and 66%, of a total number of filaments of the grounding brush 10. Moreover, in this case, a total number of the filaments 14 of the second set is between 25% and 60%, in particular between 33% and 50%, of the total number of the filaments of the grounding brush 10.

Alternatively, the grounding brush 10 is free from the filaments 14 of the second set.

Representative, non-limiting examples of the present invention were described above in detail with reference to the attached drawings. This detailed description is merely intended to teach a person of skill in the art further details for practicing preferred aspects of the present teachings and is not intended to limit the scope of the invention.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter. The invention is not restricted to the above-described embodiments, and may be varied within the scope of the following claims.

### LIST OF REFERENCE NUMERALS

| | |
|---|---|
| 10 | grounding brush |
| 12 | Filament |
| 14 | Filament |
| 16 | Filament |
| 18 | carrier unit |
| 20 | grounding brush unit |
| 22 | Device |
| 24 | Shaft |
| 26 | surface area |
| 28 | Housing |
| 30 | Part |
| 32 | Piece |
| 34 | Wire |
| 36 | carrier element |
| 38 | Lug |

We claim:

1. A grounding brush comprising:
a first set of filaments of a first type; and
a second set of filaments of a second type, the second type differing from the first type.

2. The grounding brush according to claim 1, wherein each one of the filaments of the second set of filaments consist primarily of a solid lubricant or more than one solid lubricants.

3. The grounding brush according to claim 2, wherein the filaments of the second set consist at least partially of polytetrafluoroethylene and/or of graphene.

4. The grounding brush according to claim 1, wherein the grounding brush further comprises a third set of filaments of a third type, the third type differing from the first type and from the second type.

5. The grounding brush according to claim 1, wherein each filament of the second set of filaments has a higher thermal conductivity than each filament of the first set of the filaments.

6. The grounding brush according to claim 5, wherein the filaments of the second set of filaments are Pitch-based carbon fibers.

7. The grounding brush according to claim 1, wherein:
a total number of the filaments of the first set of filaments is between 40% and 75% of a total number of filaments of the grounding brush; and/or
a total number of the filaments of the second set of filaments is between 25% and 60% of the total number of the filaments of the grounding brush.

8. A grounding brush unit with a grounding brush according to claim 1, further comprising a carrier unit fixed to the grounding brush.

9. A device with a grounding brush unit according to claim 8.

10. The device according to claim 9, further comprising a shaft with a surface area, the grounding brush contacting the surface area of the shaft and the surface area being free from coatings.
